(19) United States
(12) Patent Application Publication
(10) Pub. No.: US 2025/0363530 A1
(43) Pub. Date: Nov. 27, 2025

(54) SYSTEMS AND METHODS FOR ITERATIVE PREDICTIVE DETERMINATIONS

(71) Applicant: Atlas Labs, Inc., Seattle, WA (US)

(72) Inventors: Ethan Davidoff, Burien, WA (US); Jeffrey Ulanet, Potomac, MD (US); Singh Narinder, Chantilly, VA (US)

(21) Appl. No.: 19/216,279

(22) Filed: May 22, 2025

Related U.S. Application Data
(60) Provisional application No. 63/650,416, filed on May 22, 2024.

(51) Int. Cl. G06Q 30/0279; G06Q 40/00

(52) U.S. Cl. CPC G06Q 30/0279; G06Q 40/00

(57) ABSTRACT

The subject disclosure relates to systems, devices, and methods for determining a match between program criteria of a philanthropic aide program and data via a data mesh by employing predictive determination tools.

### CROSS-REFERENCE TO RELATED APPLICATION

This application claims priority to U.S. Patent Application No. 63/650,416 filed on May 22, 2024, and entitled “SYSTEMS AND METHODS FOR ITERATIVE PREDICTIVE DETERMINATIONS”. The entirety of the disclosures of the aforementioned application is considered part of, and is incorporated by reference, in the disclosure of this application.

### BACKGROUND

Often health insurance fails to cover the full payment of care for patient treatments, drugs, and other medical expenses. The patient is required to pay the remaining fees owed, which can be referred to as the out-of-pocket portion of the medical fee. Furthermore, the payments are often not required until after a treatment of series of treatments or medical services are performed. This can lead to the patient owing very large out-of-pocket sums. Fortunately, there are programs available to cover out of pocket costs for various patient populations (e.g., income-based threshold payments).

Regardless of the existence of such philanthropic programs, patients often have difficulty identifying the appropriate programs that can provide financial aid and are therefore unable to access such sources of funding for medical expenses. Furthermore, the application processes to become approved for such program funding are cumbersome and there is a lack of efficacious mechanisms to facilitate patient awareness and access to aid and moreover understand which of the plethora of options are best for devotion of its efforts and resources. There is a need for solutions to solve the abovementioned problems.

### SUMMARY

The following presents a summary to provide a basic understanding of one or more embodiments of the invention. This summary is not intended to identify key or critical elements or delineate any scope of the embodiments or any scope of the claims. Its sole purpose is to present concepts in a simplified form as a prelude to the more detailed description that is presented later. In one or more embodiments, described herein are systems, devices, apparatuses, computer program products and/or computer-implemented methods that facilitate a predictive likelihood of meshed data and predefined data matching a philanthropic cost reimbursement or cost coverage program.

According to an embodiment, a system is provided. The system comprises one or more processors and one or more storage devices comprising processor executable instructions that, responsive to execution by the one or more processors, cause the system to perform operations. In an aspect, an operation can include retrieving curated program data corresponding to program acceptance criteria from a program database. In another aspect, the system can retrieve predefined data from a decentralized data mesh layer based on the program acceptance criteria. In yet another aspect, the system can use a predictive analysis model to determine a probability of program acceptance based on a comparison of the predefined data to the curated program acceptance criteria.

### BRIEF DESCRIPTION OF THE DRAWINGS

FIG. 1A illustrates an example, non-limiting diagram of a representative environment 100A in which the probability of philanthropic financial aid programs is determined to cover respective medical expenses of a patient in accordance with one or more implementations described herein.

FIG. 1B illustrates an example, non-limiting example of table illustrating a weighting of tasks in accordance with one or more implementations described herein.

FIG. 2 illustrates an example, non-limiting diagram of a representative server-side environment 200 in which the probability of philanthropic financial aid programs is determined to cover respective medical expenses of a patient in accordance with one or more implementations described herein.

FIG. 3 illustrates a flow diagram of an example, non-limiting computer-implemented method that can determine a high probability determination of a philanthropic financial aid programs to cover respective medical expenses of a patient in accordance with one or more implementations described herein.

FIG. 4 illustrates a flow diagram of an example, non-limiting computer-implemented method that can determine a low probability determination of a philanthropic financial aid programs to cover respective medical expenses of a patient in accordance with one or more implementations described herein.

FIG. 5 illustrates a flow diagram of an example, non-limiting computer-implemented method that can determine a low probability determination of a philanthropic financial aid programs to cover respective medical expenses of a patient in accordance with one or more implementations described herein.

FIG. 6 illustrates a block diagram of an example, non-limiting operating environment in which one or more embodiments described herein can be facilitated. distributed scheduling system in accordance with one or more implementations described herein.

FIG. 7 illustrates a block diagram representing an exemplary non-limiting computing system or operating environment in which the various embodiments may be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section. One or more embodiments are now described with reference to the drawings, wherein like referenced numerals are used to refer to like elements throughout. In the following description, for purposes of explanation, numerous specific details are set forth to provide a more thorough understanding of the one or more embodiments. It is evident, however, in various cases, that the one or more embodiments can be practiced without these specific details.

Techniques described herein provide cloud-based platform technologies that allow for the execution of a range of operations related to determining the probability of a philanthropic financial program to provide financial support for patient medical costs. In an aspect, such determinations can be made based on implemented techniques to analyze the program criteria in reference to meshed data sets and predefined patient data sets. Various implementations receive data via a data mesh architecture from multiple data sources, identify relevant predefined attributes of the data, and execute one or more operation to determine the probabilistic relevancy of philanthropic financial program criteria to accept medical costs for coverage or reimbursement with respect to a subject patient. In various implementations, the meshed data, predefined data, and program data can be used to teach machine-learning algorithms and enhance the predictive determinations of the system. Various implementations can modify the predictive determination mechanisms employed, the inputs used to control the operations of the determination model, and the relevancy outputs generated from instance to instance. In other embodiments, techniques can be employed to extract insights related to program criteria such as the determination of anecdotal data that describes patient or therapy attributes and behaviors that contribute to a higher probability of program acceptance. Thus, by applying the machine learning models, different instances of insights can be identified from large sets of curated high probability and low probability data set determinations.

In an aspect, an example environment 100 is disclosed in which various aspects described herein can be employed.

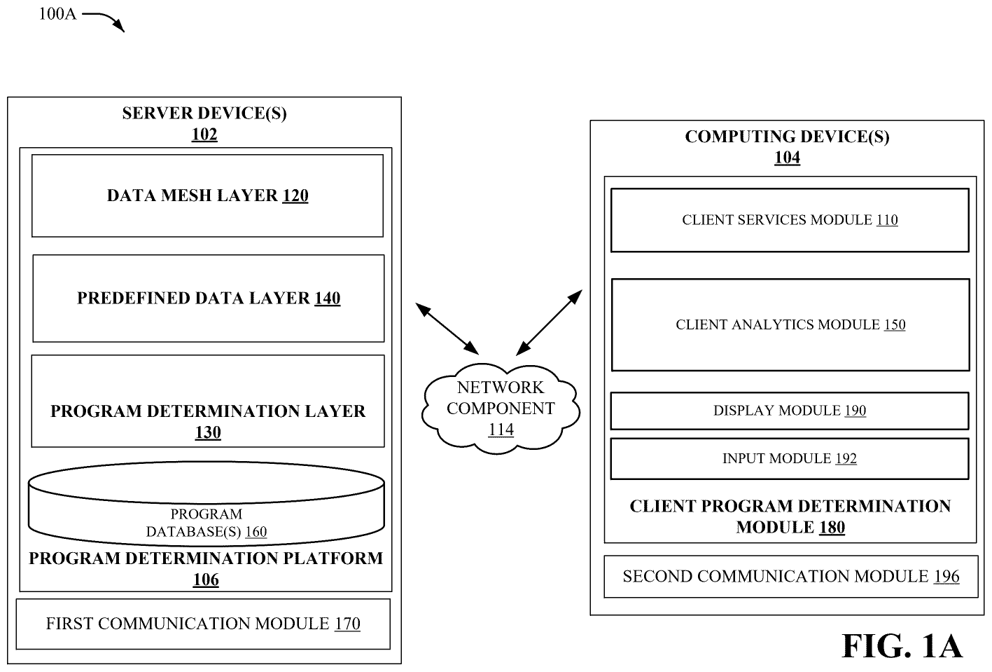

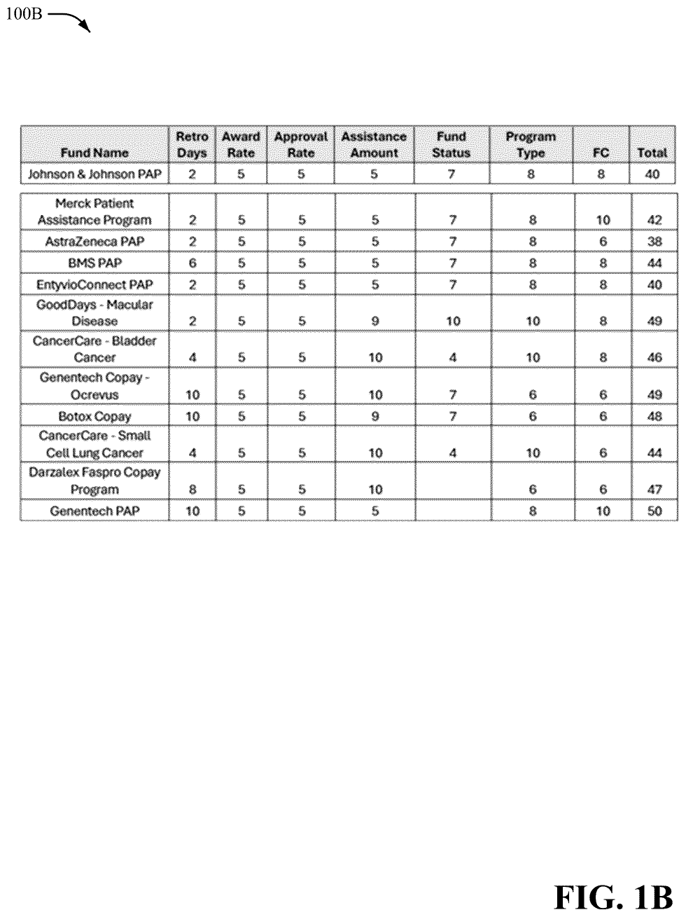

FIG. 1A illustrates an example, non-limiting diagram of a representative environment 100A in which the probability of philanthropic financial aid programs is determined to cover respective medical expenses of a patient in accordance with one or more implementations described herein.

In an aspect, environment 100A can include one or more server device(s) 102 and one or more computing device(s) 104 that, in concert, can facilitate the determination of program acceptance of various patient therapies for financial cost coverage or reimbursement. In another aspect, server device(s) 102 can employ program determination platform 106 that evaluates relevant data against varying criteria associated with each program to determine a relevancy of a program to a particular patient or therapy cost coverage or reimbursement. In one or more implementations, server(s) 102 represents server(s) that distribute various aspects of program determination platform 106 across multiple devices and/or provide cloud-based services to multiple client devices (e.g., user smart phones, laptop's, etc.). The system can use cloud-based services (e.g., can denote a suitable cloud-based service or deployment mechanism across a network such as SaaS, PaaS, IaaS models, etc.) to deploy the program determination operations in an on-demand self-service manner that allows for access to the system, a broad network, pooling of resources across several server(s), rapid elasticity and/or adaptiveness to a changing operating environment, and measured service.

Implementations can integrate several aspects of the program determination system into any one and/or combination of layers utilized by the cloud-based services. As an illustrative example, various modules and/or components can be communicatively coupled to a workload layer of a cloud computing environment to distribute the associated processing, such as development, transaction processing, analytic processing, matching processing, mapping processing, querying processing, and navigating processing in some instances.

In an aspect, program determination platform 106 can employ data mesh layer 120, predefined data layer 140, program determination layer 130, and program database(s) 160. Furthermore, the server device(s) can employ first communication module 170 to communicate with external devices and generally represent any suitable combination of hardware, software, and/or firmware configurable to facilitate the exchange of information (e.g., data, commands, queries, etc.). In another aspect, data mesh layer 120 can be configured as a decentralized and distributed framework that creates technical efficiencies in the ability to make relevancy determinations of data. For instance, data mesh layer 120 can be configured to scale optimally to take on more disparate sources of relevancy data associated with program acceptance without impairing the other data sourcing infrastructure components due to the decentralized manner of the mesh.

In another aspect, data mesh layer 120 can execute resources efficiently by optimizing the sourcing of respective data sets for specific workflows. For instance, domains of data provisioned to data mesh layer 120 can include patient information, customer information, Health Level 7 (HL7) information, various application programming interface (API) data source information that can be segregated into domains such as patient, encounter, order, plan, account, diagnosis, prescription fills, and other such domains to be pulled based on relevancy to particular program requirements. Furthermore, data that is particularly relevant to a wide swath of programs can be stored in a predefined data layer 140 allowing for the pull of predefined data more proximally by program determination layer 130. The architecture improves system response times and reduce latency associated with requests and processing. Furthermore, the localization of disparate data domains to program determination layer 130 allows for faster processing. Also, data mesh layer 120 can enable data consumptions to be distributed within and efficiently accessible for varying workflows within environment 100 and other environments disclosed herein. As such, a data domain within data mesh layer 120 may federate data for in varying operations such as transforming data into meaningful insights (e.g., transformation operations), providing compliance or quality functions (e.g., governance operations), product, data access, data processing, data storage, data governance, and other such operations. In some instances, such federated consumption of data across varying workflows can occur simultaneously given the domain-focused connectivity of data sources as independent layers within data mesh layer 120 capable of connecting to other independent layers within data mesh layer 120 and/or across varying workflow layers within environment 100.

In another aspect, the resource optimization function can further prevent over-provisioning data and under-utilizing resources (e.g., processing tools, storage requirements, etc.). Furthermore, in an aspect, data mesh layer 120 can increase accessibility (e.g., higher quality domain specific data sets can be more proximal to a data consumption destination and thus reduce latency and improve response times, and reduce friction often associated with movements over a large network). In yet another aspect, the decentralized structure of data mesh layer 120 improves system vulnerability to failures. For instance, if a particular domain of decentralized data is impeded from access, other domains can still be accessible. As such, the various fault tolerance of the system is distributed to reduce single point failure risks.

Program determination platform 106 can also employ predefined data layer 140. In an aspect, predefined data layer 140 can include initial predefined data sets determined for evaluation by program determination layer 130. The predefined data layer 140 can predefine data predicted to be required by most relevant programs based on high frequency program criteria. For instance, program determination layer 130 can determine that for a particular drug therapy cost the most relevant programs would need to evaluate a patient date of birth, the drug brand name used in the therapy, Financial Class, patient name, patient MRN, gender, drug generic name, account balance, ICD (Internal Classification of Diseases) codes, fill date, and other such information. As such, these likely data sets required for initial program relevancy determinations can be readily available in the predefined data layer 140 which can allow for faster and consistent access of domain data when evaluating the relevancy of many programs over a short period of time. Furthermore, in an aspect, predefined data layer 140 can improve the ability for consistent machine learning model training across different domains based on the organization of predefined data into common data structures.

In other implementations, program determination platform 106 can include program database(s) 160, which can represent a suitable source of data and/or information related to programs that cover medical costs for patients (e.g., charitable copay assistance programs, health equity payment programs, financial aide programs, philanthropic aide programs, etc.) including program criteria (e.g., drug name, ICD code, financial class, gender, age, zip code, etc.) required for program approval. For instance, a program may reimburse or pay for medical costs of a particular drug that correlates with a particular ICD code (e.g., for a particular disease, symptom, or injury), particular cost amount, and specific age group (e.g., older than 18).

Program database(s) 160 can store data from a range of programs along with curated program criteria. In an aspect, program database(s) 160 can communicate with program determination layer 130 to exchange information. For instance, program determination layer 130 can pull program criteria data from program database(s) 160 in accordance with a set of defined data structures and a set of rules to provide a mechanism for cross-entity data sharing. In another aspect, database(s) 160 can be configured to allow for predictable and repeatable processing by various entities within program determination platform 106.

For instance, program database(s) 160 can utilize a set of rules that allow program determination layer 130 to efficiently and successfully access and interpret program criteria data in accordance with a particular data structure (e.g., structured to allow for fast pairing to predetermination data and secondary mesh data respectively). In an aspect, such data structures can include arrays, strings, bitmaps, containers, lists, stacks, queue's, heaps, trees, graphs, objects, matrices, linked-lists, files, function parameters and other such manners in which a data can be retrieved, stored, or defined. In an aspect, such data structures can enhance performance, scalability, security, and usability of database(s) 160. In yet another aspect, database(s) 160 can employ scaling techniques (e.g., load balancing) to support program data-based workflows that may fluctuate.

In another non-limiting implementation, program determination platform 106 can employ program determination layer 130 to determine predictive relevance of various predefined data and secondary mesh data in relation to various program criteria corresponding to respective programs. As an example, predictive determination layer 130 can determine whether an infusion procedure of a particular drug would likely be accepted for financial coverage or reimbursement by philanthropic program A, philanthropic program B, and philanthropic program C. All such programs A, B, and C require the evaluation of criteria such as the drug name required for the treatment (e.g., predefined data), ICD code associated with the treatment (e.g., predefined data), and gender of the patient (e.g., predefined data). Program B and program C require zip code (e.g., secondary mesh data) and health plan data (e.g., secondary mesh data) respectively.

As such, program determination layer 130 can determine the destinations from which to request the required data, the order to employ such query requests, prioritization of such programs and program requirements, and implementation of probabilistic models to determine likelihood of respective programs to approve such cost coverage or reimbursement. Furthermore, program determination layer 130 can consider customer exclusions for philanthropic coverage availability. Also, program determination layer 130 can employ one or more machine learning model to extract insights and adjust parameters and hyper-parameters associated with predictive program relevancy models. As one example, machine learning modules of program determination layer 130 can train a machine learning model with background knowledge (e.g., knowledge of approved program criteria against specific mesh and predefined data sets) can extract insights from database(s) of highly relevant programs associated with program determination layer 130. Furthermore, the machine learning models can be employed against currently observed program data to identify the affinities such as mesh data (e.g., predetermined, and secondary data) relevancy to respective program criteria.

Accordingly, program determination layer 130 can iteratively update the machine learning models as new (e.g., program criteria, mesh data, etc.) data is processed. Furthermore, program determination layer 130 can be adjusted to deploy orderly querying operations, restructuring of predefined and secondary mesh data, and initial and iterative threshold evaluations of relevant program. In an aspect, such training can improve the execution and processing times associated with program determination layer 130 and improve the response time to program relevancy determination workloads. In a non-limiting aspect, machine learning algorithms can be deployed in different proximities (e.g., locally on a device or locally on a cloud service device) to enhance response and processing times in respective situations. The machine learning algorithms and methods can include statistic based predictive models, preference elicitation models, varied criteria decision analysis models, and other such models, and it is to be noted that such examples are disclosed for illustrative purposes only and other algorithms and methods can be disclosed without departing from the scope of the subject matter claimed herein.

In another non-limiting embodiment, program determination layer 130 can employ scoring modules to generate predictive scores representing a likelihood of financial program to provide economic benefit to a particular patient given a set of requirements. Furthermore, such scoring modules can generate scores representing one or more tasks for completion, order of task completion and likelihood of such tasks to satisfy a patients financial coverage goals. Furthermore, determination layer 130 can employ task optimization modules configured to generate operable prioritization frameworks to enable consumers to attain financial support more efficiently. For instance, one or more task optimization module can suggest stepwise areas of focus to complete based on priorities and likelihood of success such as an ordered approach to navigate the application process, advocacy suggestions for coverage of specific treatments based on likelihood of success, corrections to seek regarding improper billing issues, and other such tasks related to patient objectives. The task optimization module can provide suggestions that serve as a prescriptive process guide for patient advocates and/or patients. In another aspect, program determination layer 130 can employ a ranking module configured to rank applications based on a generated predictive score or forecast score, such that scores representing a higher likelihood of application acceptance can be discerned from scores representing lower likelihood of application success.

In a non-limiting embodiment, program determination layer 130 can employ a scoring relationship model configured to identify relationships between a forecast score and other attributes of a program such as program tasks, program value propositions, and or other data types associated with a financial program. Furthermore, the program determination layer 130 can use a schema to identify associations and dependencies between the forecast score and an attribute or characteristic of each program. In an aspect, a program characteristic can include the time until a program application submission window is closed or the total grant value associated with a program application. Accordingly, determination layer 130 can employ a module to determine a priority of tasks to be completed based on insights procured by the scoring relationship model. Furthermore, the task prioritization list can represent the ordered stepwise process to complete a program application in a manner that maximizes the opportunity for a successful program grant for the most relevant program to a patient.

In yet another aspect, determination layer 130 can prioritize tasks to enable efficient work queues for users (e.g., patient advocates) in a manner that allows a user to identify and determine a task for completion. In an aspect, determination layer 130 can rank tasks, prioritize tasks, and assign tasks to relevant users. As a non-limiting example, determination layer 130 can employ a matching engine that identifies a match for a patient and employs system logic to identify the rank of the created task. Once the task is ranked, the determination layer 130 can assign such task to a relevant user. In an aspect, the task can be displayed at a user portal for the user to complete based on a descending order of the rank value of the task. For instance, a higher rank value can indicate a more important and urgent task for completion and a lower rank value can indicate a less important and non-urgent task for completion.

In a non-limiting embodiment, determination layer 130 can identify the rank of a task based on a range of parameters such as approval rate, award rate, days retroactive, program type, financial class, and/or task type. In an aspect, an approval rate can represent a percentage likelihood of achieving an enrollment approval by a program determined by a custom approval determination model. The award rate can represent a percentage likelihood of achieving an award approved by a program as determined by a custom award rate determination model. In an aspect, a model (e.g., approval determination model, award rate determination model, etc.) can be a learning model that utilizes tasks (e.g., classification, regression, clustering, generation, etc.) to extract learnings to generate predictions of award rates, approval rates, and other such predictions. In another aspect, days retroactive can represent the number of days remaining for a patient enrollment to occur. For instance, days retroactive can be represented as a system date less a date of service. In another aspect, other parameters can include a program type, financial class (e.g., representing financial class of the primary insurance source of a patient user), task type (e.g., representing a type of task to be performed by an advocate).

In another aspect, determination layer 130 can apply weights for each parameter based on the value of the parameter. For instance, an approval rating percentage of between 81-100 percent can correspond to the highest weight of ten (10) on a weightage range of 1 to 10, but an approval rate of between 0 to 20% can correspond to a weightage of two on a weightage range of one to ten. Similarly, weightage can correspond to award rate percentage parameters as well. In another aspect, parameters such as days retroactive can correspond to weightage, such as an application that is retroactive 180 to 365 days prior to submission can correspond to a weightage of ten whereas a zero to 59 days retroactive application can correspond to a weightage of two with 10 haven't the greatest task priority weight and one having the lowest task priority weight. As such, an application with a greater number of days retroactive can have a lower task priority. Furthermore, program type parameters can correspond to weightage as well. For instance, programs of program type copay can correspond to a lower weightage such as a six (lower task priority) and a program corresponding to a higher weightage such as disease based assistance funds (DBAF) can correspond to a greater weightage, indicating the program has a more urgent program type to be accessed for patients.

In another aspect, determination layer 130 can factor a financial class (e.g., Medicare, Medicare Advantage, Medicare Part A, Medicare Part D, commercial payor, self-pay, etc.) parameter into a task prioritization determination. For instance, a financial class that requires an applicant to have a commercial insurance coverage may correspond to a lower task priority such as a weight of four and a financial class of Medicare or Medicare Advantage may correspond to a higher weight of eight. In another instance, determination layer 130 can factor in a task type (e.g., Review Match, Review DOS, Obtain Consent, Submit Docs—EOB, Submit Docs—Enroll, Track-Enroll, Track-EOB, Log Award, Enroll, etc.) into a task priority determination. Accordingly, the type of task to be performed can correspond to the task prioritization. For instance, a task type of performing a review match can correspond to a high weight of ten, however, a task of Track-Enroll may correspond to a low weight of a two indicating a lower priority.

In another aspect, determination layer 130 can configure the weights based on each customer. Furthermore, determination layer 130 can implement default weights of five (5) for missing values or parameters lacking a weight. In a non-limiting embodiment, higher numerical values can correspond to higher ranks of task priority over other such tasks. As an example, determination layer 130 can determine which of task 1, task 2, and task 3 has a higher priority for completion. Task 1 is a review match with 27 days retroactive, an award rate of 89, an approval rate of 89, a program type of DBAF, and a financial class (FC) of Medicare Advantage. Task 2 has a task type of a review match, DOS-retro of 2, an award rate of 86, an approval rate of 84, a program type of free drug, and an FC of Medicare AB. Task 3 has a task type of submit DOCS-enroll, DOS-Retro of five, award rate of 93, an approval rate of 65, a program type of free drug, and an FC of self-pay.

Determination layer 130 can determine a final score for task 1 of 49, task 2 of 53.5, task 3 of 50.5. As such, the system can order a task queue for a user (e.g., patient advocate) to perform task 2 first, then task 3, and then task 1. The system can determine that given that only two days remain for the retroactive period for a self-pay patient (e.g., patient does not have insurance coverage) who needs to be enrolled to a free drug program with a high approval and high award rate, such task is more important for the user to complete in order not to forfeit the opportunity to obtain medication coverage for a patient compared to task 1 and task 3 where there are more days remaining in the retroactive period and where the patient already has insurance coverage.

In another non-limiting scenario, determination layer 130 may determine that based on patient data and program criteria, a patient may have multiple matches. In such instance, determination layer 130 can employ recommendation and matching modules to determine the best match within a task. As a non-limiting example, determination layer 130 can utilize parameters such as days retroactive (e.g., number of days remaining to enroll a patient), program type, financial class, fund status representing the status capturing whether the fund is open, approval rate, award rate, and an assistance amount representing a grant amount allocated by the determination layer 130 to the patient. In an aspect, weights can correspond to each parameter. The fund status parameter can include DBAF Open, PAP, Copay, DBAF Closed/Waitlist fund status. As a non-limiting example, a DBAF Open fund status can correspond to a ten weight (high task priority), DBAF closed correspond to a weight of one. In an aspect, the assistance amount parameter can include a highest value assistance amount (e.g., assigned a ten weight), an assign 2 less points for each fund based on assistance amount (e.g., 10-n), and if assistance amount is unknown a corresponding weight of five is assigned. As such, if any of the parameters has missing data or values, then determination layer 130 defaults the weight to five.

Determination layer 130 can determine a rank and recommend a match with the highest rank on top of the priority list within a task to the patient advocate user. In an aspect, a user interface can render all the review match tasks under multiple matches in descending order of rank value. As a non-limiting example, in FIG. 1B, fund name Johnson & Johnson PAP has a total weight of 40 and Genentech PAP has a total weight of 50. As such, the highest-ranking fund name is Genentech PAP.

In an aspect, determination layer 130 can implement checkpoint logic to generate tasks and assign ranks of tasks. The determination layer 130 can implement checkpoints such as duplication logic, waiting for patient responsibilities, and waiting for DBAF to open. In an aspect, when generating an enrollment task, determination layer 130 validates whether or not a patient is already enrolled in a program. If a patient is not enrolled in a program, determination layer 130 generates an enrollment review match task. In the event the enrollment review match task exists already (e.g., enrollment is in progress but not approved yet), and the DOS and encounter ID for the patient record is same, the system does not create any new task as the enrollment review match task is already in progress.

If a patient is not enrolled to the program, but the enrollment-review match task already exists, and the DOS and encounter ID for the patient record is different than the enrollment task, then determination layer 130 generates a post enrollment-review DOS task but does not surface the task to the advocate until the enrollment is complete. Once the enrollment is completed and flagged as approved, determination layer 130 surfaces a post enrollment-review DOS task for the advocate. In the event a patient is already enrolled to the program, and the DOS and encounter ID for the patient record is different than the enrollment task, the determination layer 130 generates the post enrollment-review DOS task. In the event a patient is already enrolled into the program, but the enrollment expired, determination layer 130 generates the re-enrolment task.

With respect to the task associated with Copay and DBAF programs, determination layer 130 does not generate the task for the patient advocate until the patient responsibility is received from the health system or until 30 days from the DOS or the encounter associated with the task. If the patient responsibility received from the health system is $0, then determination layer 130 does not surface the task and auto close the task as not needed given the patient no longer has any financial responsibility. Determination layer 130 generates the task after 30 days from DOS even if the patient responsibility is still not received from the health system, is configurable by customer and the days can be changed from DOS when the task should be generated by the customer. Determination layer 130 can also support configuration options where Copay and DBAF tasks are surfaced prior to DOS and prior to patient responsibility being available.

With respect to waiting for DBAF to open parameters, for enrollment-review match task associated with DBAF programs, the system does not display the task to the patient advocate until the DBAF program is open. In the event the DBAF program is open for re-enrollment only, determination layer 130 will display the task for the patient who is eligible for re-enrollment.

In another aspect, determination layer 130 can employ two mechanisms to assign tasks to advocates. In an aspect, determination layer 130 can employ default logic and patient advocate relationship logic, both of which can be configured for a customer use. In an aspect, default logic can be employed once a task record is generated and rank is calculated, determination layer 130 can pull all advocates and its associated user settings (e.g., benefit type, program types, locations, and task types that advocates configured to work on). In an aspect, determination layer 130 pulls the number of tasks in progress for the advocate. Furthermore, based on the benefit type, program type, location, and task type of the task, determination layer 130 identifies the advocates with same user criteria and assigns tasks randomly. In another aspect, determination layer 130 can employ patient advocate relations logic to identify the advocate who worked on a most recent task for a patient and assigns the same advocate to the newer task. If an advocate associated with the most recent task for the patient is no longer a part of the organization or the patient does not have any previous task, then determination layer 130 can employ atlas default logic to assign the advocate.

In yet another aspect, determination layer 130 can employ a MAP portal support to auto reject and update a task from a patient advocate task list if the task is not validated anymore. As per such logic, determination layer 130 can identify all the tasks where the DOS on the encounter is out of the retroactive period and a patient advocate user has not commenced work, and auto close respective tasks with reason as task DOS out of the retroactive period.

Turning now to client device(s) 104 in FIG. 1A, such devices can include smart phones, tablets, laptops, smart watches, and any other suitable type of computing device. Computing device(s) 104 can employ client program determination module 180 and second communication module 196 configured to communicate with external device(s) such as server device(s) 102 in accordance with communication protocols such as network communication protocols, wireless or wired communication sessions or other such communication protocols (e.g., IMAP, FTP, TCP, UDP, HTTP, etc.). Furthermore, second communication module 196 can communicate with server device(s) 102 via first communication module 170. In a non-limiting implementation, client program determination module 180 can employ client services module 110, client analytics module 150, display module 190, and input module 192.

In an aspect, client services module 110 can be configured to access the services available via program determination platform 106 such as determining program relevancy, clinical service management, program enrollment and automated enrollment capabilities, claims data filtering, reimbursement monitoring and enrolment tracking capabilities, and other such service access. Furthermore, client services module 110 can allow for querying program determination layer 130. In another aspect, client analytics module 150 can access reports, dashboards, and other information. Furthermore, via client analytics module 150 databases for curation and incorporation into data mesh layer 120 can be accomplished. In another aspect, display module 190 can be configured to allow for the rendering of information on device(s) 104 interface. In another aspect, input module 192 can be configured to allow user access into program determination platform 106.

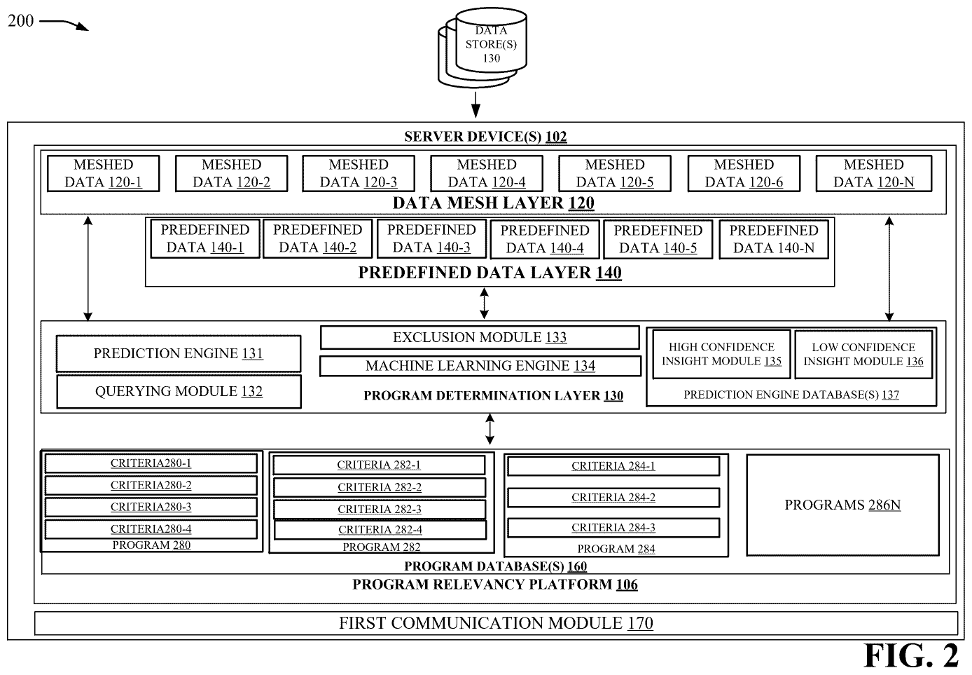

Turning now to FIG. 2, illustrated is an example, non-limiting diagram of a representative server-side environment 200 in which the probability of philanthropic financial aid programs is determined to cover respective medical expenses of a patient in accordance with one or more implementations described herein. Repetitive description of like elements employed in other embodiments described herein is omitted for sake of brevity.

Server-side environment 200 comprises data store(s) 130 (e.g., data sources for data mesh layer 120), data server(s) 102 which employs program relevancy platform 106 and first communication module 170. Furthermore, environment 200 includes program relevancy platform 106 which employs data mesh layer 120, predefined data layer 140, program determination layer 130, and program database(s) 160. In an aspect, data mesh layer can include meshed data 120-1 (e.g., representing patient data), meshed data 120-2 (e.g., representing encounter data), meshed data 120-3 (e.g., representing order data), meshed data 120-4 (e.g., representing plan data), meshed data 120-5 (e.g., representing account data), meshed data 120-6 (e.g., representing diagnosis data), and meshed data 120-N (e.g., representative of any number of additional meshed data or data attributes such as prescriptions, drug fills, zip codes, etc.).

The predefined data layer 140 can include a range of data types and data sets that may correspond to program criteria that can contribute to a program relevancy determination. In an aspect, predefined data layer 140 employs predefined data 140-1 (e.g., date of birth) predefined data 140-2 (e.g., gender), predefined data 140-3 (e.g., drug brand name), predefined data 140-4 (e.g., financial class), predefined data 140-5 (e.g., ICD code), predefined data 140-N (e.g., any other of a range of predefined data). In another aspect, program determination layer 130 can be configured to employ prediction engine 131, querying module 132, exclusion module 133, machine learning engine 134 prediction engine database(s) 137. In another aspect, prediction engine database(s) 137 can employ high confidence insight module 135 and low confidence insight module 136.

The programs can vary by type, criteria, use, purpose, attributes, scope of services covered, financial contributions allowable, etc. For instance, one program may focus on funding research for new treatments of which a needy patient may be participating in a therapy that meets such goals and requires financial contributions. In another aspect, a program may only fund preventative care and focus on therapy type such as vaccinations, screenings, health education, and other such focus. In other instances, programs can focus on match contributions (e.g., to Health Savings Accounts), helping families afford insurance premiums, target specific diseases (e.g., cancer), cover costs for specific items (e.g., medications, surgery, etc.), and other such variations. Furthermore, each program can have varying criteria that can range from significant departures to direct matches of criteria between different programs.

As illustrative in environment 200, program relevancy platform 106 can include program 280, program 282, program 284, and programs 286N (e.g., representing any number of additional programs). Furthermore, program 280 can correspond to criteria 280-1 (e.g., Drug criteria), criteria 280-2 (e.g., ICD code criteria), criteria 280-3 (e.g., FC criteria), and criteria 280-4 (e.g., gender criteria). In another aspect, program 282 can correspond to criteria 282-1 (e.g., Drug criteria), criteria 282-2 (e.g., ICD code criteria), criteria 282-3 (e.g., FC criteria), and criteria 282-4 (e.g., age criteria requiring a threshold age greater than 18 years old). In yet another aspect, program 284 can correspond to criteria 284-1 (e.g., Drug criteria), criteria 284-2 (e.g., FC criteria), criteria 284-3 (e.g., zip code criteria).

In an aspect, program determination layer 130 can employ prediction engine 131 configured to execute predictions of relevancy of programs based on analysis of meshed data and predefined data as compared to program criteria data stored in program database(s) 160. In an aspect, prediction engine 131 can employ predictor functions, machine-learned algorithms, and other modules, tools, or applications to determine affinities for programs to accept qualifying mesh data and/or predefined data. For instance, prediction engine 131 may determine an age greater than a target threshold age combined with the name of a generic drug having a particular cost are predictors of higher likelihood of a particular subset of program acceptance (e.g., programs directed at elderly assistance and treatment of a particular ailment that affects a critical mass of such population).

In another aspect, program determination layer can employ querying module 132 to query or trigger the querying of data sets such as program criteria, mesh data, and/or predefined data. For instance, if a date of birth of a patient is predefined data but zip code data is required for a program acceptance, then querying module 132 can trigger an automated query to pull zip code data from mesh data layer 120. Program determination layer 130 can be configured to allow for faster query analysis operations by employing the mesh frameworks and architectures which are decentralized and allow for quick retrieval of domain-based data via data mesh layer 120. In an aspect, querying module 132 can include contextual parameters to various queries of program database 160, data mesh layer 120, predefined data layer 140. In another aspect, data store(s) 130 can include various data source configured to provision data to data mesh layer 120 and various data domains. As a non-limiting example such data sources can include HL7 standardized data, data via application programming interfaces (API's), customer data files, patient data file sources, and other such data domains.

In another aspect, program determination layer 130 can employ exclusion module 133 configured to apply a set of customer exclusionary limitations to programs determined (e.g., via program determination layer 170 including prediction engine 131) to have a high likelihood of relevancy to a patient. Accordingly, outside of program limitations customers may have policies, restrictions, rules, and limitations on what type of program funding they may accept. As such, exclusion module 133 can be configured to address each customers custom exclusions.

In yet another aspect program determination layer 130 can include prediction engine database(s) 137 configured to store relevant program data. In an aspect, prediction engine database(s) 137 can employ high confidence insight module 135 configured to store program data subsets, data mesh layer subsets, and predefined data subsets that correspond to gradations of high confidence of respective program acceptance. In an aspect, prediction engine 131 can determine whether a program is above or below a target threshold confidence interval (e.g., 85%, 90%, 95%, etc.) of program acceptance and provision such data to high confidence insight module 135 if above such target threshold or to low confidence insight module 136 if below such target threshold likelihood.

In another non-limiting embodiment, program determination layer 130 can employ machine learning engine 134 to employ any of a range of algorithms such as machine learning algorithms (e.g., random forest algorithm), data mining algorithms, and or principal component analysis algorithms to identify relationships between new data evaluated by prediction engine 131 and data within prediction engine database(s) 137. In an aspect, machine learning engine 134 can employ machine learning models disclosed throughout this disclosure including random forest algorithms. Machine learning engine 134 can enhance and optimize processing speed and accuracy of predictive results of programs likely to approve funding for particular patients.

In a non-limiting example, prediction engine 137 can extract learned information from machine learning engine 134 and update its prediction model by adjusting model parameters and/or hyper-parameters to create a more accurate determination of program probabilistic approval on each iterative operational execution. Furthermore, the system can employ learnings and insight extraction across a broad swath of data subsets and trained data subsets. Accordingly, the behavior of prediction engine 137 can be iteratively and continuously improving based on learnings from machine learning engine 134.

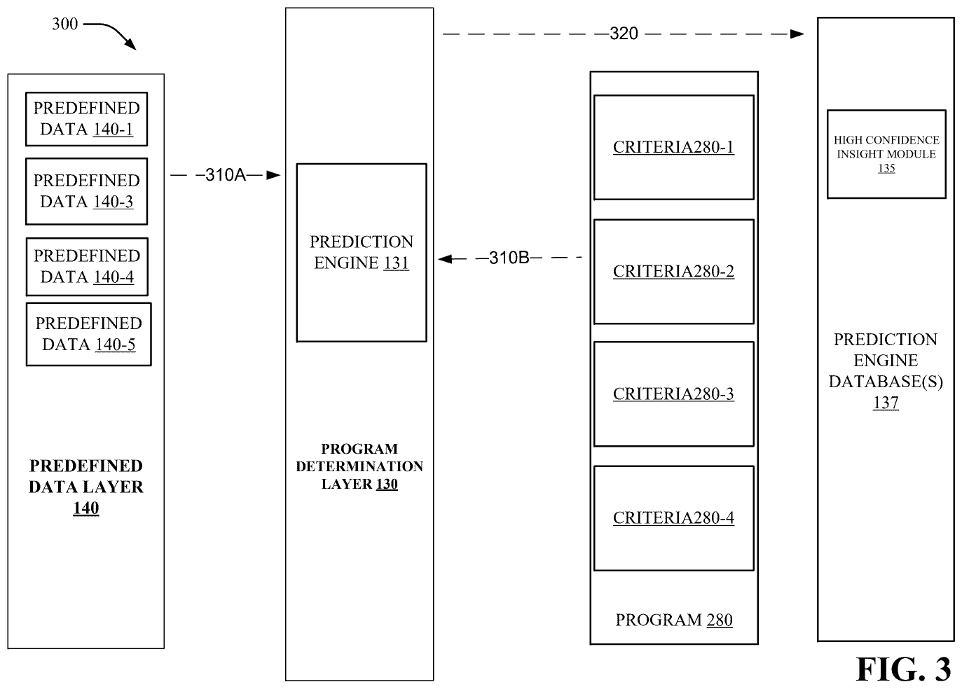

Turning now to FIG. 3, illustrated is a flow diagram of an example, non-limiting computer-implemented method 300 that can determine a high probability determination of a philanthropic financial aid programs to cover respective medical expenses of a patient in accordance with one or more implementations described herein. Repetitive description of like elements employed in other embodiments described herein is omitted for sake of brevity.

In an aspect, method 300 included predefined data layer 140, program determination layer 130, program 282, and prediction engine database(s) 137. At reference numeral 310A, program determination layer 130 employs prediction engine 131, to request predefined data 140-1 (e.g., Gender—Male), predefined data 140-3 (e.g., drug name A), predefined data 140-4 (e.g., FC), predefined data 140-5 (ICD code-1111) from predefined data layer 140. At reference numeral 310B, program determination layer 130 employs prediction engine 131 to extract program 280 program criteria including criteria 280-1 (e.g., gender requirement male), criteria 280-2 (drug name A), criteria 280-3 (FC), and criteria 280-4 (ICD code-1111).

Prediction engine 131 determines that predefined data 140-1 (e.g., Gender—Male), predefined data 140-3 (e.g., drug name A), predefined data 140-4 (e.g., FC), predefined data 140-5 (ICD code-1111) satisfy program 280 and corresponding criteria 280-1 (e.g., gender requirement male), criteria 280-2 (drug name A), criteria 280-3 (FC), and criteria 280-4 (ICD code-1111). As such, at reference numeral 320, prediction engine 131 provisions the respective data set to the high confidence insight module 135 container of prediction engine database(s) 137. As such method 300 provides an illustrative example of a match between all program criteria and relevant predefined data.

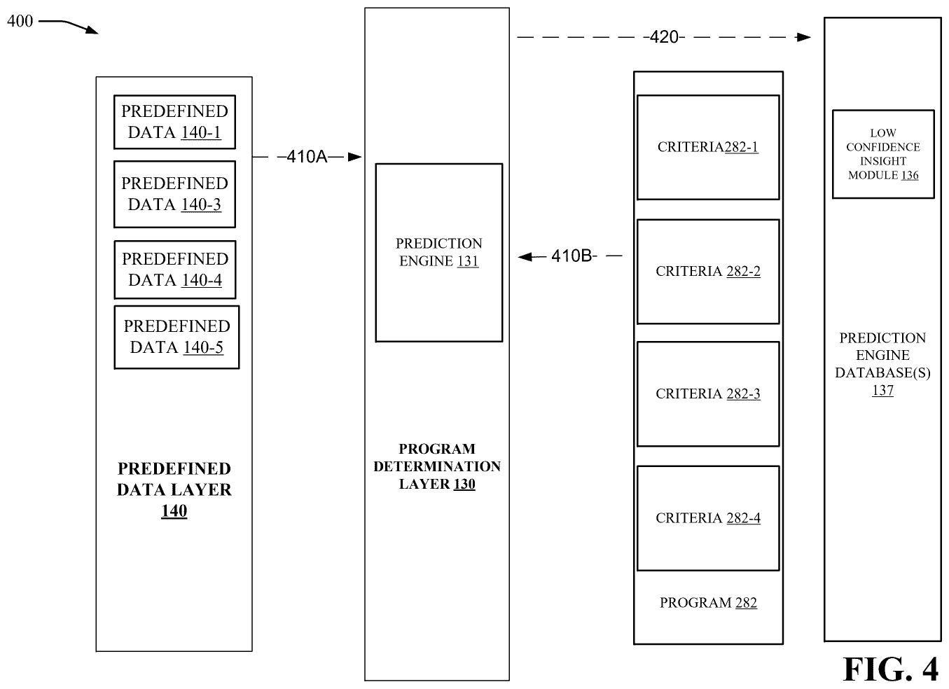

Turning now to FIG. 4, illustrated is a flow diagram of an example, non-limiting computer-implemented method 400 that can determine a low probability determination of a philanthropic financial aid programs to cover respective medical expenses of a patient in accordance with one or more implementations described herein. Repetitive description of like elements employed in other embodiments described herein is omitted for sake of brevity.

In an aspect, method 400 included predefined data layer 140, program determination layer 130, program 282, and prediction engine database(s) 137. At reference numeral 410A, program determination layer 130 employs prediction engine 131, to request predefined data 140-1 (e.g., DOB represents a 16-year-old child applying), predefined data 140-3 (e.g., drug name A), predefined data 140-4 (e.g., FC), predefined data 140-5 (ICD code-1111) from predefined data layer 140. At reference numeral 410B, program determination layer 130 employs prediction engine 131 to extract program 282 program criteria including criteria 282-1 (e.g., age requirement older than 18), criteria 282-2 (drug name A), criteria 282-3 (FC), and criteria 282-4 (ICD code-1111).

Prediction engine 131 determines that predefined data 140-1 (e.g., DOB represents a 16 year old child applying), predefined data 140-3 (e.g., drug name A), predefined data 140-4 (e.g., FC), predefined data 140-5 (ICD code-1111) do not satisfy program 282 and corresponding criteria 282-1 (e.g., age requirement must be older than 18 years old), criteria 282-2 (drug name A), criteria 282-3 (FC), and criteria 282-4 (ICD code-1111). As such, at reference numeral 410, prediction engine 131 provisions the respective data set to the low confidence insight module 136 container of prediction engine database(s) 137. As such method 400 provides an illustrative example of a low or failed match between all program criteria and relevant predefined data.

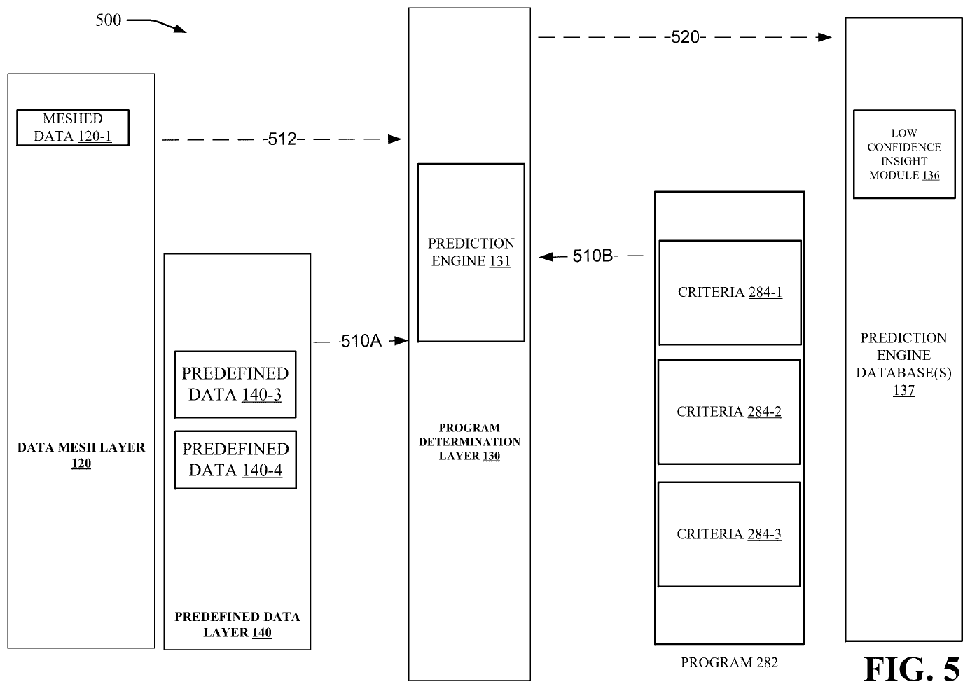

Turning now to FIG. 5, illustrated is a flow diagram of an example, non-limiting computer-implemented method 500 that can determine a low probability determination of a philanthropic financial aid programs to cover respective medical expenses of a patient in accordance with one or more implementations described herein. Repetitive description of like elements employed in other embodiments described herein is omitted for sake of brevity.

In an aspect, method 500 included predefined data layer 140, program determination layer 130, program 282, and prediction engine database(s) 137. At reference numeral 510A, program determination layer 130 employs prediction engine 131, to request predefined data 140-3 (e.g., drug brand name A), predefined data 140-4 (e.g., FC), At reference numeral 510B, program determination layer 130 employs prediction engine 131 to extract program 284 program criteria including criteria 284-1 (e.g., drug brand name A), criteria 284-2 (FC), and criteria 282-3 (Zip code 2222). At reference numeral 512 program determination layer 130 requests meshed data 120-1 (Zip code 7777).

Prediction engine 131 determines that predefined data predefined data 140-3 (e.g., drug brand name A), predefined data 140-4 (e.g., FC), and no zip code information exists in predefined layer 140. As such, at reference numeral 512, prediction engine 131 pulls meshed data 120-1 (zip code 7777). Prediction engine 131 provisions the meshed data 120-1, predefined data 140-3. Predefined data 140-1 and program 284 criteria to low confidence insight module 136 container of prediction engine database(s) 137. As such method 500 provides an illustrative example of a low or failed match between all program criteria and relevant predefined data and illustrates the ordered provisioning or pulling of data from data mesh layer 120 after program determination layer 130.

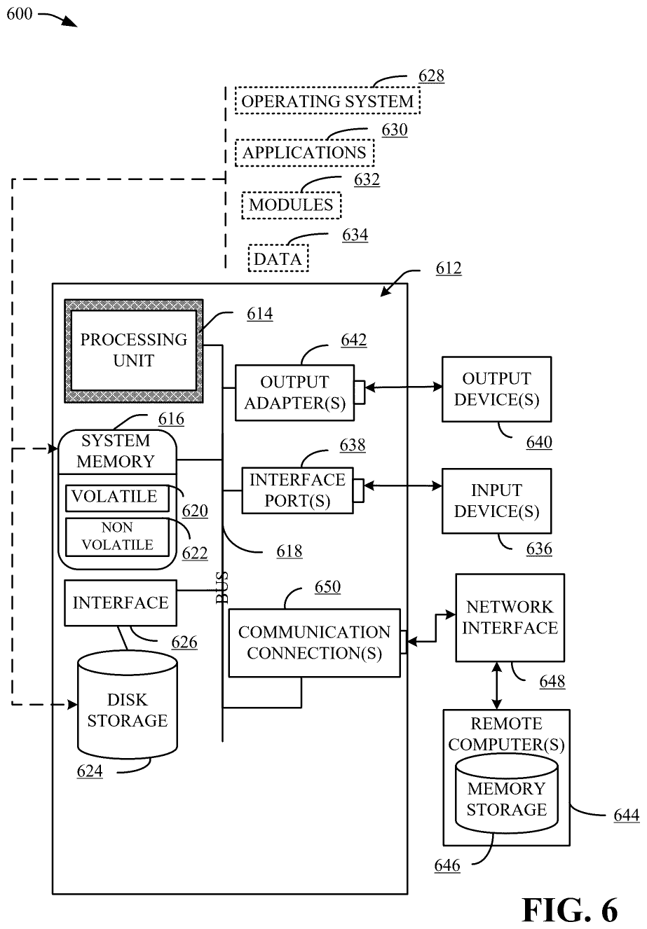

FIG. 6 illustrates a block diagram of an example, non-limiting operating environment in which one or more embodiments described herein can be facilitated. distributed scheduling system in accordance with one or more implementations described herein.

To provide a context for the various aspects of the disclosed subject matter, FIG. 6 as well as the following discussion is intended to provide a general description of a suitable environment in which the various aspects of the disclosed subject matter can be implemented. FIG. 6 illustrates a block diagram of an example, non-limiting operating environment in which one or more embodiments described herein can be facilitated. With reference to FIG. 6, a suitable operating environment 600 for implementing various aspects of this disclosure can also include a computer 612. The computer 612 can also include a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614. The system bus 618 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 616 can also include volatile memory 620 and nonvolatile memory 622. The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable programmable ROM (EEPROM), flash memory, or nonvolatile random-access memory (RAM) (e.g., ferroelectric RAM (Ferbam). Volatile memory 620 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synch link DRAM (SLDRAM), direct Rambus RAM (DRRAM), direct Rambus dynamic RAM (DRDRAM), and Rambus dynamic RAM.

Computer 612 can also include removable/non-removable, volatile/non-volatile computer storage media. FIG. 6 illustrates, for example, a disk storage 624. Disk storage 624 can also include, but is not limited to, devices like a magnetic disk drive, floppy disk drive, tape drive, Jaz drive, Zip drive, LS-100 drive, flash memory card, or memory stick. The disk storage 624 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 624 to the system bus 618, a removable or non-removable interface is typically used, such as interface 626. FIG. 6 also depicts software that acts as an intermediary between users and the basic computer resources described in the suitable operating environment 600. Such software can also include, for example, an operating system 628. Operating system 628, which can be stored on disk storage 624, acts to control and allocate resources of the computer 612.

System applications 630 take advantage of the management of resources by operating system 628 through program modules 632 and program data 634, e.g., stored either in system memory 616 or on disk storage 624. It is to be appreciated that this disclosure can be implemented with various operating systems or combinations of operating systems. A user enters commands or information into the computer 612 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port can be used to provide input to computer 612, and to output information from computer 612 to an output device 640. Output adapter 1242 is provided to illustrate that there are some output devices 640 like monitors, speakers, and printers, among other such output device 640, which require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a computer, a server, a router, a network PC, a workstation, a microprocessor-based appliance, a peer device, or other common network node and the like, and typically can also include many or all the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 650 refers to the hardware/software employed to connect the network interface 648 to the system bus 618. While communication connection 650 is shown for illustrative clarity inside computer 612, it can also be external to computer 612. The hardware/software for connection to the network interface 648 can also include, for exemplary purposes only, internal and external technologies such as, modems including regular telephone grade modems, cable modems and DSL modems, ISDN adapters, and Ethernet cards.

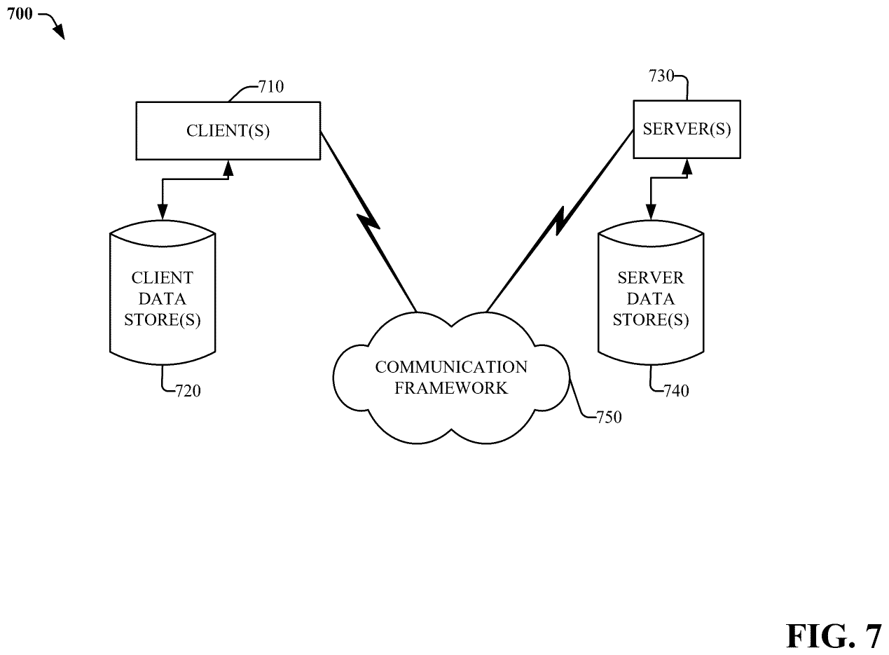

FIG. 7 illustrates a block diagram representing an exemplary non-limiting computing system or operating environment in which the various embodiments may be implemented.

Referring now to FIG. 7, illustrated is a schematic block diagram of a computing environment 700 in accordance with this disclosure. The system 700 includes one or more client(s) 702 (e.g., laptops, smart phones, PDAs, media players, computers, portable electronic devices, tablets, and the like). The client(s) 702 can be hardware and/or software (e.g., threads, processes, computing devices). The system 700 also includes one or more server(s) 704. The server(s) 7t04 can also be hardware or hardware in combination with software (e.g., threads, processes, computing devices). The servers 7t04 can house threads to perform transformations by employing aspects of this disclosure, for example. One possible communication between a client 7t02 and a server 7t04 can be in the form of a data packet transmitted between two or more computer processes wherein the data packet may include video data. The data packet can include a metadata, e.g., associated contextual information, for example. The system 7t00 includes a communication framework 706 (e.g., a global communication network such as the Internet, or mobile network(s)) that can be employed to facilitate communications between the client(s) 7t02 and the server(s) 7t04.

Communications can be facilitated via a wired (including optical fiber) and/or wireless technology. The client(s) 702 include or are operatively connected to one or more client data store(s) 708 that can be employed to store information local to the client(s) 702 (e.g., associated contextual information). Similarly, the server(s) 704 are operatively include or are operatively connected to one or more server data store(s) 710 that can be employed to store information local to the servers 704. In one embodiment, a client 702 can transfer an encoded file, in accordance with the disclosed subject matter, to server 704. Server 704 can store the file, decode the file, or transmit the file to another client 702. It is to be appreciated, that a client 702 can also transfer uncompressed file to a server 704 and server 704 can compress the file in accordance with the disclosed subject matter. Likewise, server 704 can encode video information and transmit the information via communication framework 706 to one or more clients 702.

The present disclosure may be a system, a method, an apparatus and/or a computer program product at any possible technical detail level of integration. The computer program product can include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. In yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random-access memory (RAM) (e.g., ferroelectric RAM (ferbam). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), syncline DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices, and drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system comprising:
one or more processors; and
one or more storage devices comprising processor executable instructions that, responsive to execution by the one or more processors, cause the system to perform operations comprising:
retrieving curated program data corresponding to program acceptance criteria from a program database;
retrieving predefined data from a decentralized data mesh layer based on the program acceptance criteria; and
determine, using a predictive analysis model, a probability of program acceptance based on a comparison of the predefined data to the curated program acceptance criteria.

2. The system of claim 1 further comprising:
training a machine learning model on high probability program acceptance data;
extracting insights from the machine learning model;
adjusting one or more parameter of the predictive analysis model based on the extracted insights.

3. A system comprising:
a processing system that implements a program probability of acceptance determination comprising:
a data mesh engine configured to:
intake domain-specific data from one or more set of decentralized data sources;
a program curation engine configured to:
curate program data based on program acceptance criteria;
store the curated program data and corresponding curated program acceptance criteria at a program database;
a program determination engine configured to:
retrieve predefined data of the data mesh based on the curated program acceptance criteria; and
determine, using a predictive analysis model, a probability of program acceptance based on a comparison of the predefined data to the curated program acceptance criteria.

4. The system of claim 3, wherein the program determination engine is further configured to:
retrieve secondary data of the data mesh based on the predictive analysis model failure to match all the curated program acceptance criteria to the predefined data.

5. The system of claim 3, wherein the program determination engine is further configured to:
determine whether the probability of program acceptance is greater than a target threshold probability of program acceptance; and
provision a subset of any one of the program data, the secondary data, or the predefined data to a high confidence prediction engine database based on the probability of the program acceptance that is greater than the target threshold probability of program acceptance.

6. The system of claim 3, wherein the program determination engine is further configured to:
determine whether the probability of program acceptance is lower than a target threshold probability of program acceptance; and
provision a subset of the program data to a lower probability prediction engine database based on the probability of the program acceptance that is greater than the target threshold probability of program acceptance.

7. The system of claim 3, wherein the program determination engine is further configured to:
generate a forecast score that represents the probability of program acceptance as compared to a program; and
ranking a set of programs including the program based on the forecast score.

8. The system of claim 7, wherein the program determination engine is further configured to:
identify relationships between the forecast score of a program and program characteristic based on a score relationship model; and
generate a prioritization hierarchy of program tasks for completion based on the identified relationships between the forecast score of a program and program task requirements

9. The system of claim 7, wherein the program value propositions are any one or more of a value of a program award or an application time period representing a start date of a program application until a closing date of the program application.
